(19) United States
(12) Patent Application Publication
(10) Pub. No.: US 2014/0165449 A1
(43) Pub. Date: Jun. 19, 2014

(54) FISHING LURE

(71) Applicant: James Joseph Yelton, Rushsylvania, OH (US)

(72) Inventor: James Joseph Yelton, Rushsylvania, OH (US)

(21) Appl. No.: 13/961,081

(22) Filed: Aug. 7, 2013

Related U.S. Application Data
(63) Continuation-in-part of application No. 13/590,983, filed on Aug. 21, 2012.
Application No. 13/590,983 is a continuation-in-part of application No. 12/931,965, filed on Feb. 15, 2011, now Pat. No. 8,245,437.

(51) Int. Cl. A01K 85/14

(52) U.S. Cl. CPC A01K 85/14
USPC 43/42.02; 43/42.45; 43/42.09

(57) ABSTRACT

A fishing lure having a bent half-moon shape body. The top portion of the fishing lure having at least one attachment point. The bottom portion of the fishing lure is angled relative to the top portion. The shape of the fishing lure resulting in an up and down motion of the lure as it is dragged through the water.

### CROSS-REFERENCE TO RELATED APPLICATIONS

This application is a continuation-in-part of U.S. application Ser. No. 13/590,983 filed Aug. 21, 2012, which is a continuation-in-part of U.S. application Ser. No. 12/931,965 filed Feb. 15, 2011, now U.S. Pat. No. 8,245,437, both of which are incorporated by reference as if fully rewritten herein.

### TECHNICAL FIELD

Exemplary embodiments of the present invention relate to a fishing lure. More particularly, the present invention relates to a fishing lure that may be used independently with attachment points for hooks or as a flasher for fishing.

### BACKGROUND

Man has endeavored for centuries to master the art of fishing. Accordingly, man has sought out innovative methods and devices in order to ensure a productive day of fishing. Devices in use range from carefully crafted flies to artfully painted lures. With advancements in fishing technology comes increased specialization and increased cost. As such, there is a need for a cheap multipurpose fishing lure.

### SUMMARY OF THE INVENTIVE CONCEPT

Exemplary embodiments of the present invention provide individuals with a cheap and effective fishing lure. The fishing lure embodying the inventive concept has a body having a bent half-moon configuration. The body has a top portion and a bottom portion. The bottom portion encompasses the rounded portion of the half-moon shape. Holes are drilled into the top portion to allow the attachment of hooks and line. To increase the lures attractiveness to fish an eye may be stamped into both sides of the lure to further mimic the natural prey of fish.

In other exemplary embodiments, the lure may have a single attachment point and can be used in connection with a variety of bait assemblies. Specifically, the lure may be used as a flasher or blade. The inventive shape of the lure causes the lure to experience an up and down motion as it is being pulled through the water. When the lure is attached to a bait assembly that up and down motion is imparted to bait assembly to more closely mimic live bait. The up and down motion of the lure may be controlled by the type of connection to the bait assembly. By connecting the lure to a fixed point on the bait assembly, the up and down motion of the lure may simply be a pivoting about the connection point. If a longer flexible connection is used, the lure may pivot as well as travel in an arc about the bait assembly.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is a front view of an exemplary embodiment of a fishing lure in accordance with the inventive concept;

FIG. 2 is a top perspective view of a fishing lure in accordance with the inventive concept;

FIG. 3a is a front view of another exemplary embodiment of a fishing lure in accordance with the inventive concept that may be used as a flasher;

FIG. 3b is a front view of another exemplary embodiment of a fishing lure in accordance with the inventive concept;

FIG. 4 is a side view of an exemplary embodiment of an inventive fishing lure;

FIG. 5 is a perspective view of an exemplary embodiment of a fishing lure in accordance with the inventive concept used with a bait assembly;

FIG. 6 is a side view illustrating the movement of the fishing lure in accordance with the inventive concept as used with a bait assembly;

FIG. 7 is a perspective view of an exemplary embodiment of a fishing lure in accordance with the inventive concept used with a bait assembly;

FIG. 8 is a perspective view of an exemplary embodiment of a fishing lure in accordance with the inventive concept used with a bait assembly; and

FIG. 9 is a perspective view of an exemplary embodiment of a fishing lure in accordance with the inventive concept used with a bait assembly and elastic body.

### DETAILED DESCRIPTION OF EXEMPLARY EMBODIMENT(S)

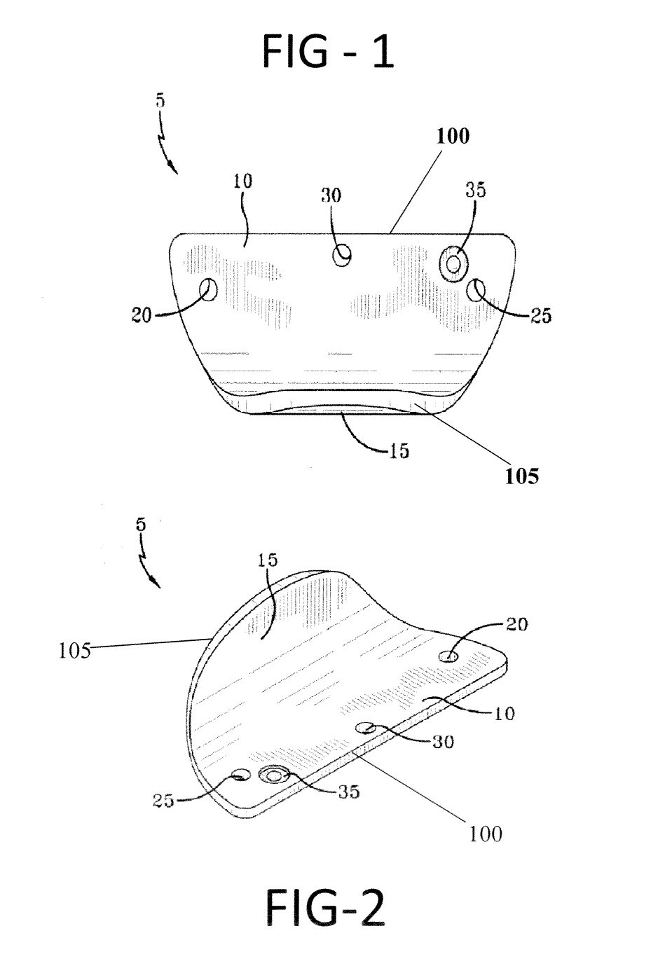

An exemplary embodiment of the lure 5 according to the inventive concept is illustrated in FIG. 1. As shown in FIG. 1, the lure 5 is constructed from a rigid piece of material having a bend therein. Specifically, the lure 5 begins as a circular segment that is an area of a circle informally defined as an area which is cut-off from the rest of the circle by a secant or a chord. The circle segment constitutes the part between the secant and an arc, excluding the circle's center. Accordingly, this circle segment has some arc measurement less than 180°. In other exemplary embodiments, the lure 5 may be a semicircle. As used herein the semicircle is a two-dimensional geometric shape that forms half a circle. The arc of a semicircle measures 180° or half a turn. Embodiments of the lure 5 are formed from a portion of a circle cut off from the circle by a chord, including a semicircle, and may have an arc measuring between about 130° to about 180°. More specifically, the arc may have a measurement of about 140°. The area of the lure 5 is defined by the arc of the circle and the chord of the circle. Accordingly, as used herein, half-moon will describe the beginning piece of material for the lure 5 as described above and will be defined as such.

The lure 5 is constructed from a half-moon piece of rigid material. The rigid material may be metal, plastic, ceramic, or other similar rigid material. In some embodiments, the lure 5 may be coated to prevent corrosion due to moisture. The lure 5 has a top portion 10, formed from the chord of the circle forming a straight edge 100, and a bottom portion 15, formed from the arc of a circle, forming a rounded edge 105. Both the top portion 10 and the bottom portion 15 are further defined by the bend in the lure 5. The bottom portion 15 is the rounded edge 105 of the half-moon shape and represents approximately 30% to about 50% of the height of the half-moon shape.

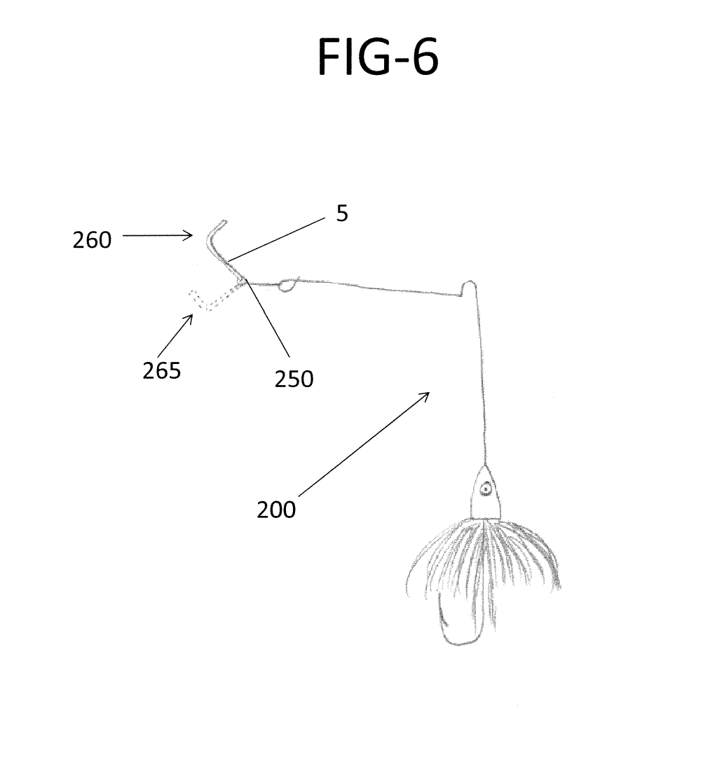

To accomplish the desired motion in the water (up and down motion illustrated in FIG. 6), the bottom portion 15 should be bent to about a 70° to about 90° angle relative to the top portion 10. This bend and body shape allows the lure 5 to replicate the movement of live bait in order to attract fish. Given the starting half-moon shape of the material used to create the lure 5, once the bend is formed to form the lure 5, the shape may be described as a bent half-moon shape. Thus, the bent half-moon shape is a circle segment defined by a chord of a circle and an arc measuring between about 130° to 180° having about a 70° to about 90° bend therein creating a bottom portion representing approximately 30% to about 50% of the height of the starting half-moon shape.

In some embodiments, the lure 5 may have attachment points for hooks or lines. A series of holes 20, 25, 30 are placed in the lure 5 for attachment of the hooks and lines. The holes 20, 25, 30 are located in the top portion 10 of the lure 5. The first hole 20 and the second hole 25 are located near each corner formed by the intersections of the straight edge 100 with the rounded edge 105 of the top portion 10 and the third hole 30 is centrally located near the edge 100. As should be understood by those having skill in the art, hooks and lines may be attached to the holes 20, 25, 30 in a variety of configurations. Different hook and line configurations may impart different lure 5 movements in the water.

To make the lure 5 more attractive to fish, a feature mimicking an eye may be stamped in the top portion 10. In such embodiments, the eye 35 is stamped or formed into the rigid material along the straight edge 100 of the top portion 10, as shown in FIGS. 1 and 2. The eye 35 may be stamped or formed on both sides of the lure 5 to increase its visibility to passing fish.

FIG. 2 is a perspective view of the lure 5 further illustrating the bend in the rigid body of the lure 5. Although described as a bend, it should be understood that the lure 5 may be formed with the bend therein rather than actually bending the material. FIG. 2 better illustrates the relationship between the top portion 10 and the bottom portion 15. Although described as the top portion 10 and the bottom portion 15, it should be understood by those skilled in the art that either the bottom portion 15 or the top portion 10 may have a higher elevation in the water depending on orientation and movement. Accordingly, during movement of the lure 5 through the water the bottom portion 15 and the top portion 10 may alternate between higher and lower elevations relative to one another (described more fully herein). It is this motion that allows the lure 5 to mimic live bait and attract fish.

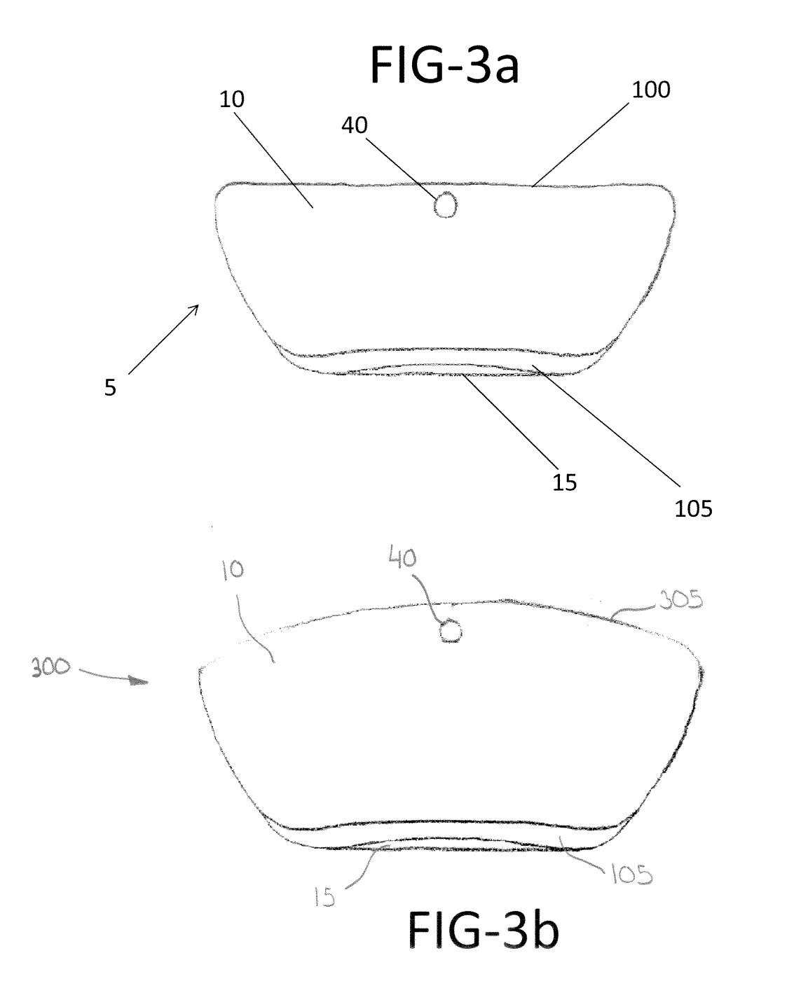

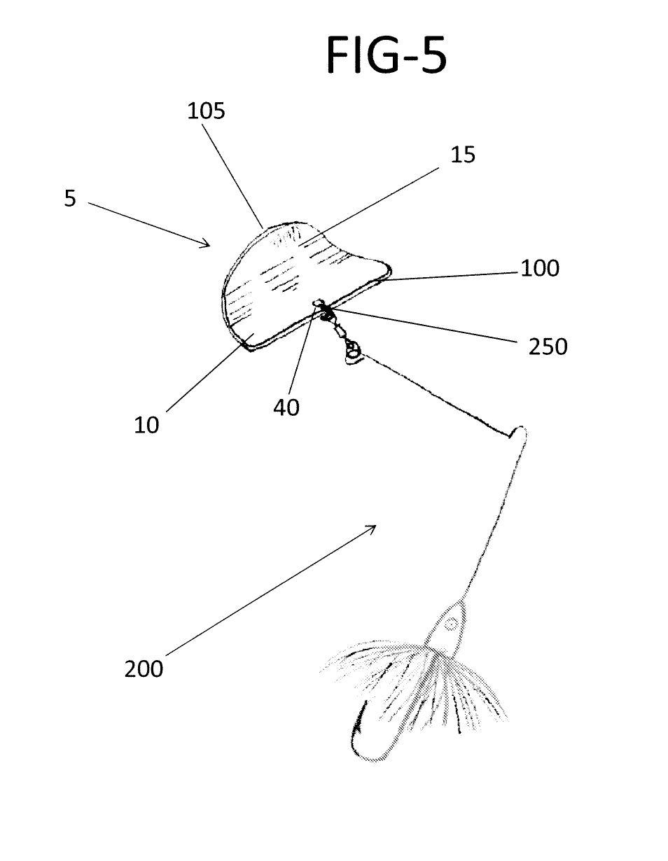

In other exemplary embodiments of the lure 5, there may be a single attachment point 40, as shown in FIG. 3a. In this embodiment, the lure 5 may be used as part of a large, more complex bait assembly 200 (shown in FIGS. 5 and 6). The attachment point 40 serves to connect the lure 5 to the rest of the bait assembly 200 and is located centrally in the top portion 10 near the edge 100. In this embodiment, the lure 5 may act as the flasher or blade portion of the larger bait assembly 200. The motion of the lure 5 is imparted to the rest of the bait assembly 200 to attract fish. Whether used alone or in combination with a bait assembly 200, the overall shape of the lure 5 remains as described herein.

FIG. 3b illustrates another exemplary embodiment of a lure 300 in accordance with the inventive concept. The lure 300 is similar in most respects to lure 5 represented in FIGS. 1-3. Lure 300 has a top and bottom portion 10, 15 as well as an attachment point 40 centrally located in the top portion 10. Lure 300 also has a rounded edge 105 defining the bottom portion 15. However, rather than having a straight edge 100, the lure 300 has a second rounded edge 305 defining the top portion 10. The inclusion of a second rounded edge 305 helps prevent snags allowing for smooth retrieval of the lure 300. As shown, the second rounded edge 305 has a greater arc length than the first rounded edge 105. It should be understood by those of skill in the art that the lure 300 may also alternatively include the series of holes 20, 25, 30 for use without a bait assembly. Additionally, the lure 300 may be used in conjunction with a variety of bait assemblies such as jigs, spoon lures, plugs, swimbaits, and other types of fishing lures.

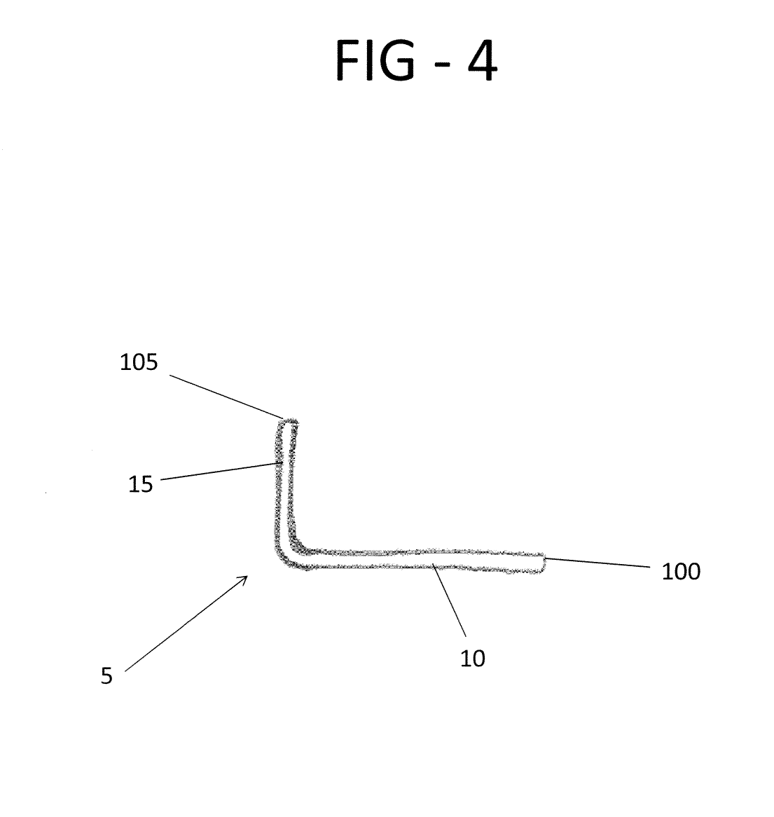

FIG. 4 is a side view of the lure 5 illustrating the bend in the half-moon shape of the lure 5. As can be seen in FIG. 4, the bottom portion 15 is at a 90° angle relative to the top portion 10 as described herein.

The lure 5 may be used as part of the larger bait assembly 200 as shown in FIG. 5. The lure 5 is connected to the bait assembly by way of attachment point 40. As recognized by one of ordinary skill in the art the bait assembly 200 depicted in FIG. 5 is commonly referred to as a safety pin spinnerbait. The movement and pressure created by pulling the lure 5 through the water attracts fish to the bait assembly 200. Although the bait assembly 200 is shown as a safety pin spinnerbait, one of skill in the art should understand that the lure 5 can be connected to and used with jigs, spoon lures, plugs, swimbaits and other types of fishing lures.

FIG. 6 shows the up and down motion of the lure 5 according to the inventive concept. As with FIG. 5, FIG. 6 illustrates the lure 5 connected to a bait assembly. Due to the inventive shape and design of the lure 5, the lure 5 begins to move up and down. Depending on the type of connection between the lure 5 and the bait assembly 200, the lure 5 may pivot about the connection point 250, as shown in FIGS. 5 and 6. Depending on the lure's 5 attachment to the bait assembly, the lure 5 may also move up and down as if traveling in an arc. However, unlike typical spinnerbaits, the lure 5 does not spin. As illustrated, the lure 5 moves between an up position 260 and a down position 265, the down position illustrated by the dotted lines in FIG. 6. This movement created by the lure 5 creates reflections due to its own motion that may attract fish. In addition, the motion of the lure 5 may be imparted to the bait assembly 200 to more accurately mimic live bait.

Another feature of the lure 5 is its ease of manufacture. The lure 5 may start as a circular piece of rigid material. The half-moon shape of the lure 5 allows for multiple lures 5 to be cut from a single circular piece of rigid material. The holes 20, 25, 30 or attachment point 40 may be drilled in the lure 5. The half-moon shaped lure 5 may then be bent into its final shape creating the bent half-moon shape of the lure 5. During the process the eye 35 may be stamped, if desired.

The lure 5 according to the inventive concept is simple to use, as it does not require specialized bait assemblies or casting techniques to use. In addition, the lure 5 is functional over a wide range of drawing speeds and can be used alone or with a variety of bait assemblies 200. The type and degree of the up and down motion of the lure 5 may be adjusted by simply adjusting the connection between the lure 5 and the bait assembly 200. The lure 5 also lacks points preventing line tangles while in use.

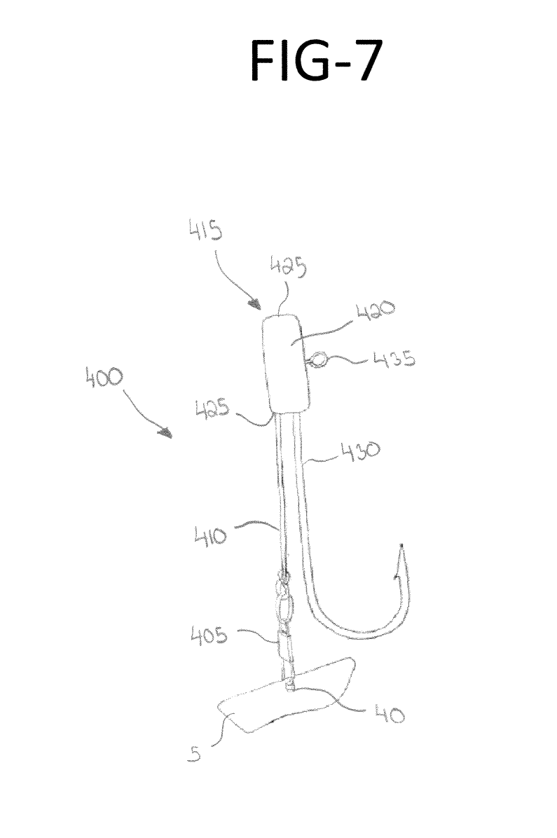

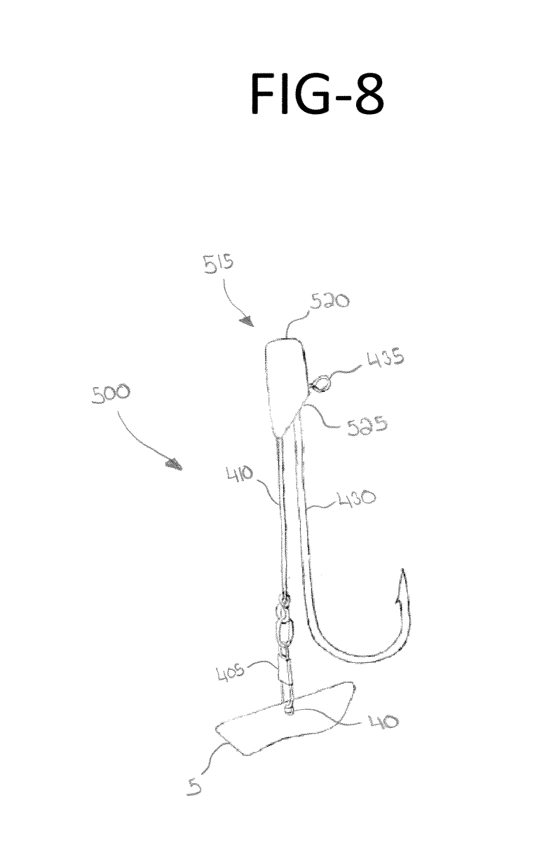

As stated above, the lures 5, 300 may also be used with a jig bait assembly 400, illustrated in FIGS. 7-8. As shown in FIG. 7, the lure 5 is connected to the bait assembly 400 by way of attachment point 40. A snap 405 is used at the attachment point 40 to connect the lure 5 to a wire 410. The wire 410 extends from and is molded into a bait body 415. The bait body 415 may be constructed from lead or other metal, or may be constructed from a weighted polymer to promote proper movement through the water. The bait body 415 may have a cylindrical shape having a cylindrical surface 420 and opposing ends 425. The wire 410 extends from an opposing end 425 and a hook 430 also extends from the same opposing end 425 in the same direction as the wire 410. To attach the bait assembly 400 to fishing line a loop 435 is provided. The loop 435 extends from the bait body 415 substantially perpendicular to the hook 430 and wire 410.

FIG. 8 is another type of jig bait that may benefit from the use of a lure 5, 300 according to the inventive concept. As illustrated, bait assembly 500 is a jig bait and is identical to the bait assembly 400, except for the shape of the bait body 515. In this embodiment, the bait body 515 has a cylindrical segment or truncated cylinder shape. Rather than having two opposing ends 425, the bait body 515 has an end 520 and a slanted end 525. This shape results in an uneven weight distribution in the bait body 515 causing the hook 430 to have a higher elevation than the wire 410 when in the water. This uneven weight distribution results in the hook 430 riding higher in the water and decreases the possibility of the hook 430 snagging on debris as the bait assembly 500 is retrieved.

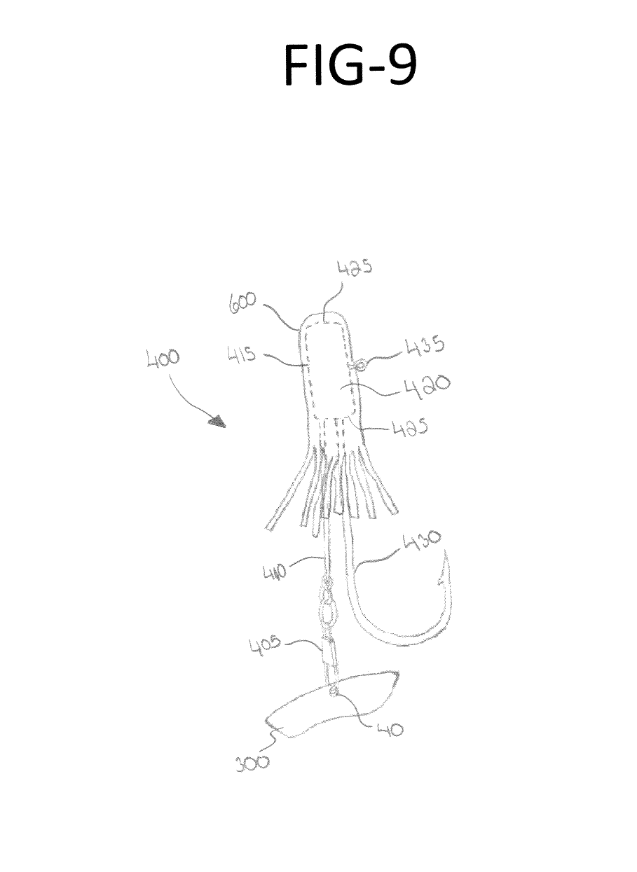

FIG. 9 illustrates a bait assembly 400 having a lure 300 attached thereto. In addition, the bait body 415 is covered by an elastomeric covering 600. The elastomeric covering 600 is designed to resemble aquatic life in order to entice a desired fish. As illustrated, the elastomeric covering 600 may have a tube section 605 and a skirt portion 610. The bait body 415 is inserted into the elastomeric covering 600 and nests in the tube section 605. The loop 435 extends through the elastomeric covering 600 and attached to fishing line. The skirt portion 610 extends from the tube section 605 and aids in disguising the bait assembly 400. As shown, the lure 300 is attached to the bait assembly 400 by way of attachment point 40. As should be understood by those skilled in the art, lure 5 and lure 300 may be substituted one for another in the embodiments described herein.

While certain embodiments of the present invention are described in detail above, the scope of the invention is not to be considered limited by such disclosure, and modifications are possible without departing from the spirit of the invention as evidenced by the following claims:

What is claimed is:

1. A fishing lure comprising:
a body having a half-moon shape, said body having a top portion and a bottom portion separated by a bend in said body; and
an attachment point located in said top potion of said body.

2. The fishing lure of claim 1, wherein said bend is located so that about 30% to about 50% of said lure is positioned below said bend.

3. The fishing lure of claim 2, wherein said bottom portion having a 70 degree to about 90 degree angle relative to said top portion.

4. The fishing lure of claim 1, wherein said top portion is defined by a straight edge and said bend and said bottom portion is defined by a rounded edge and said bend.

5. The fishing lure of claim 1, further comprising first and second rounded edges, wherein said bottom portion is defined by said first rounded edge and said bend and said top portion is defined by said second rounded edge and said bend.

6. The fishing lure of claim 1, wherein said second rounded edge has a greater arc length than said first rounded edge.

7. The fishing lure of claim 1, further comprising a bait assembly attached thereto at said at least one attachment point.

8. The fishing lure of claim 1, wherein said lure moves in an up and down motion while being pulled through the water.

9. The fishing lure of claim 1, wherein said up and down motion of said lure is imparted to a bait assembly attached thereto.

10. A fishing lure comprising:
a body formed from a rigid material, said body having the shape of a circular segment;
a bend in said body, said bend forming a top portion and a bottom portion, said top portion defined on one side by a chord of said circular segment and said bottom portion formed by an arc of said circular segment;
at least one attachment point located in said body; and
a bait assembly attached to said at least one attachment point.

11. The fishing lure of claim 10, wherein said arc is between about 130° and 180°.

12. The fishing lure of claim 10, wherein said arc has a measurement of about 140°.

13. The fishing lure of claim 10, further comprising a circular stamp is said top portion.

14. The fishing lure of claim 10, further comprising a bait assembly attached to said lure at said at least one attachment point.

15. The fishing lure of claim 10, wherein said bottom portion includes about 30% to about 50% of said body.

16. The fishing lure of claim 10, wherein said body is made from metal.

17. The fishing lure of claim 10, wherein said bottom portion has a 70° to 90° angle relative to said top portion.

18. The fishing lure of claim 10, wherein said lure moves up and down when pulled through water.

19. The fishing lure of claim 12, wherein said bait assembly is a tube jig.

20. A fishing lure comprising:
a body, said body having a half-moon shape;
a bend in said body, said bend forming a top portion and a bottom portion, said top portion defined on one side by a chord of said half-moon shape and said bottom portion formed by an arc of said half-moon shape;
at least one attachment point located in said body;
a bait assembly attached to said lure at said at least one attachment point, including;
a bait body;
a wire extending from said bait body;
a hook extending from said bait body, said hook extending in the same direction as said wire; and
a snap connecting said body and said wire.
